(19) United States
(12) Patent Application Publication
(10) Pub. No.: US 2004/0210866 A1
(43) Pub. Date: Oct. 21, 2004

(54) Method of creating a unit test framework to test a resource description framework based object

(76) Inventors: Richard Friedman, Cherry Hill, NJ (US); Joseph J. Snyder, Shamong, NJ (US); Jason A. Kinner, Marlton, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/417,932

(22) Filed: Apr. 17, 2003

(51) Int. Cl. G06F 9/44

(52) U.S. Cl. 717/106

(57) ABSTRACT

The specification may disclose a method comprising creating a unit test framework to test a Resource Description Framework (RDF) based object, and creating a plug-in to access an application program interface (API) of the RDF based object by the unit test framework.

### BACKGROUND

Resource Description Framework (RDF), as defined by the World-Wide Web Consortium (W3C), may be a model for storing information. More particularly, the RDF model may be designed for storing of information about information—METADATA. METADATA in the RDF model is grouped using a logical triple. In its simplest form, the triple may comprise a subject, a predicate and an object. For example, the statement “Leslie is 34 years old” may be broken down into the triple subject=Leslie, predicate=age, and object=“34.” Thus, the predicate that links the subject “Leslie” to the object “34” may be the property ‘age.’ In more technical terms, the triple of the RDF model may be defined by a resource (subject), property (predicate), and object. Although the resource in the simple example given above was “Leslie,” in the RDF model a resource may be anything which may be assigned a Universal Resource Identifier (URI). One example of the resource that may be assigned an URI is a document posted to the world-wide web. A document with a URI may be as simple as a digital image, or may be as complex as a series of commands read by a web browser to create a viewable web page.

The RDF model may not define properties or predicates; rather, the RDF model may only define the relationship of storing METADATA in the form of a triple. Thus, the general population may be free to define any series of properties which may be relevant to their particular genre of subjects. Each of these defined set of properties may be referred to as a schema, a RDF schema, or a “namespace.” The RDF model, as well as the various schema that have been produced or may be produced, may not be a programming language. Rather, METADATA information may be coded in extensible Markup Language (XML). For the METADATA to be useful, a user may need to access, modify, query and delete METADATA. In particular, an entity that creates a RDF schema may need to verify that the model created, as well as the application program interface for the model, work correctly.

### SUMMARY

The specification may disclose a method comprising creating a unit test framework to test a Resource Description Framework (RDF) based object, and creating a plug-in to access an application program interface (API) of the RDF based object by the unit test framework.

The specification may also disclose a computer readable media comprising an executable program that, when executed, implements a method such as accepting a test script by a unit test framework system for RDF based information, communicating from the unit test framework system to the RDF based information through an API, and producing results of tests formulated in response to the test script and applied to the RDF based information.

### BRIEF DESCRIPTION OF THE DRAWINGS

For a detailed description of the embodiments of the invention, reference will now be made to the accompanying drawings in which:

FIG. 1 may illustrate a block diagram of components of embodiments of the invention;

FIG. 2 may illustrate a more detailed block diagram of components of embodiments of the invention; and

FIG. 3 may illustrate a more detailed block diagram of components of embodiments of the invention for use with a Jena application program interface.

### NOTATION AND NOMENCLATURE

Certain terms are used throughout the following description and claims to refer to particular components and systems. As one skilled in the art will appreciate, computer and software companies may refer to a component by different names. This document does not intend to distinguish between components and systems that differ in name but not function. In the following discussion and in the claims, the terms “including” and “comprising” are used in an open-ended fashion, and thus should be interpreted to mean “including, but not limited to . . . ”.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the present invention may be directed to a unit test framework for testing information, such as METADATA, coded using a Resource Description Framework (RDF) model. Information coded using the RDF model may be alternatively referred to as a RDF based object, RDF based METADATA, RDF leveraged METADATA, and the like. A unit test framework may be a testing methodology, a set of methods invoked to test an object, and a user interface to report results of the tests whether favorable or unfavorable. More specifically, a unit test framework may be utilized during a development cycle of an object, such as a software algorithm or a database coded using the RDF model, to test whether the object operates in a manner expected.

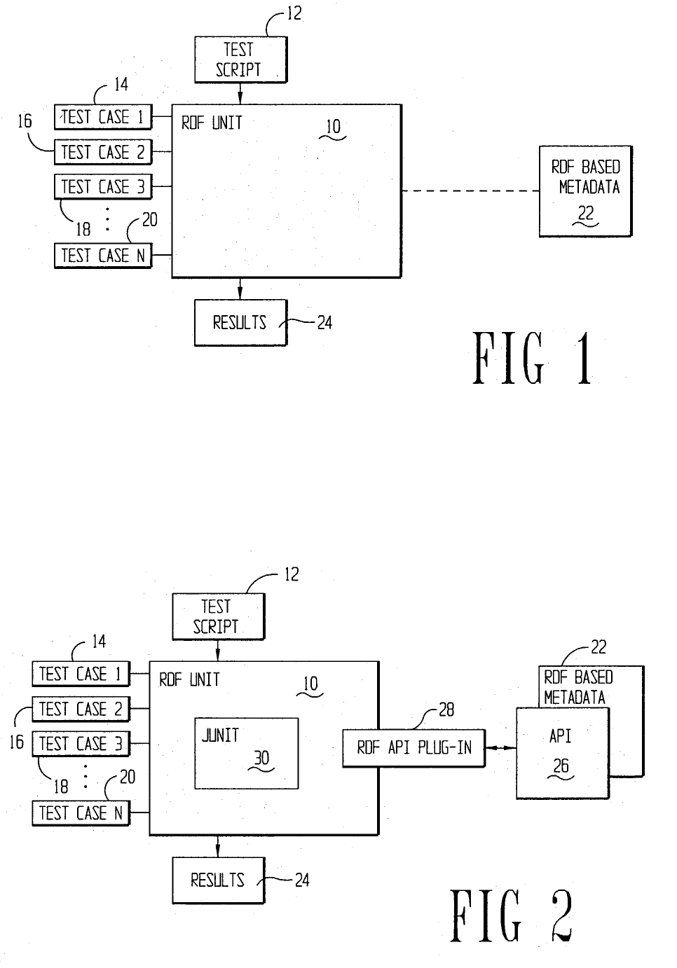

FIG. 1 illustrates a block diagram of components of embodiments of the invention. In particular, embodiments of the invention may be directed to a unit test framework for testing operability of RDF based METADATA, RDF Unit 10. The RDF Unit 10 may take as an input a test script 12 which may instruct the RDF Unit 10 to assemble and prepare one or more test cases 14, 16, 18, 20 for testing on the RDF based METADATA 22. More particularly, the test script 12 may instruct the RDF Unit 10 to apply a single test case to the RDF based METDATA 22, or the test script 12 may instruct the RDF Unit 10 to assemble a plurality of test cases, a test suite, to be applied to the RDF based METADATA 22.

A test case may invoke a method related to the RDF based METADATA 22. For example, and without limitation, a test case may insert a relationship in the RDF based METADATA 22, update a relationship, modify a relationship, and/or query based on a property of a subject to discover an object. Using the exemplary relationship described in the Background section, a test case may update the relation subject=Leslie, predicate=age, and object=“34” to make the object=“35.” Likewise, a test case may modify and/or add a relationship. For example, a test case may add an additional predicate=birthday, and object=“Sep. 7, 1968” for the subject Leslie. The actions invoked by test cases described thus far may not have return values (or may not have return values related to the success or failure of the operation). Thus, the test cases may also query the RDF based METADATA 22, possibly to ascertain whether other actions are correctly reflected in the METADATA 22. A test suite, comprising a series of test cases, may thus modify and/or write the METADATA 22, query the METADATA 22 to determine return values, and then make a determination of whether the desired modify and/or write actions are correctly reflected. Finally, the RDF Unit 10 may produce an indication of the results 24 of the test case(s). The results may be in the form of a command-line response, or may alternatively be passed to a user by way of a graphical user interface.

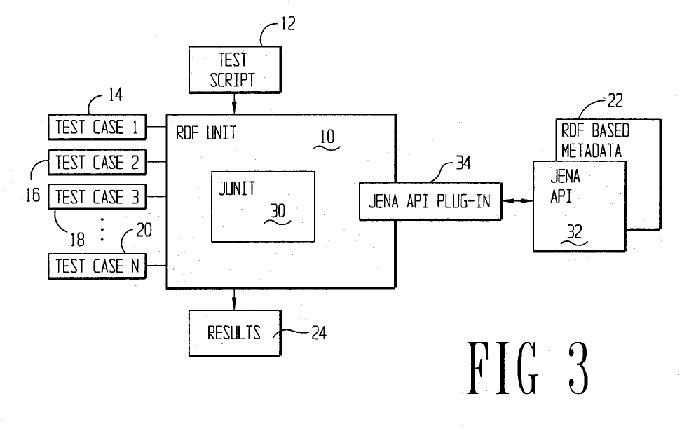

FIG. 2 may illustrate in greater detail various embodiments of the invention. In particular, RDF based METADATA 22 may be coded in extensible Markup Language (XML), and thus, unlike individual program objects, may not itself be executable. Access to the RDF based METADATA 22 may be accomplished though an application program interface (API) 26. In at least some embodiments of the invention, the API 26 may be a Java-language program that may allow other programs to access the RDF based METADATA 22 by execution of methods of the API 26. However, the API 26 may take many forms, such as, without limitation, a C programming language interface, a C++ interface, a C# (sharp) interface, and the like. Co-pending application serial number titled, “METHOD OF GENERATING IMPLEMENTATIONS FOR A RESOURCE DESCRIPTION FRAMEWORK (RDF) INPUT SOURCE,” (HP Docket No. 100203208-1 (Atty. Docket No. 2162-04500)) which is assigned to the same assignee as the present specification, and is incorporated by reference herein as if reproduced in full below, may describe in greater detail creation of native-language APIs for RDF based METADATA.

Still referring to FIG. 2, the RDF Unit 10 of the embodiments of the invention may likewise be programmed in Java; however, another programming language may be equivalently used. RDF Unit 10 may thus execute its test case(s) by communication with the API 26 of the RDF based METADATA 22. In embodiments of the invention, however, the RDF Unit 10 may be used generically for any RDF based METADATA 22, possibly independent of the API 26. Thus, in at least some embodiments, a RDF API plug-in 28 may be generated. The RDF API plug-in 28 may facilitate communication between the RDF Unit 10 and the RDF based METADATA 22 by allowing communication from the generic RDF Unit 10 to the API 26 for the particular system. In alternative embodiments of the invention, the RDF Unit 10 may have the capability to communicate with an API 26 directly, or may even have an integrated API such that communication for execution of test cases on the RDF based METADATA 22 may take place directly.

The RDF Unit of various embodiments of the invention may be created without reference to or use of other unit test frameworks. However, in some embodiments the RDF Unit 10 may be based on unit test technology from alternative fields, such as unit testing executable software components. More particularly, in at least some embodiments of the invention the RDF Unit 10 may be a software wrapper around a Java Unit (JUnit) 30. JUnit may be an open source, regression testing framework for Java based applications. Information regarding JUnit, as well as the JUnit programs, may be obtained at http://www.junit.org. Of particular use, in the creation of an RDF Unit 10, may be the “assert” clauses predefined in the JUnit system. These “assert” clauses may assess whether results returned from operations on, or queries to, the RDF based METADATA 22 match expected results. For example, the RDF Unit 10 may utilize “assertEqualso” method (which may be overloaded to accepted several data types) of JUnit while determining whether returned data was as expected. It should be understood, however, that while creation of a RDF Unit in accordance with embodiments of the invention may be based on other unit test frameworks, that RDF Unit 10 may be coded without reference to or based on such other unit test frameworks.

RDF Unit 10 may prepare and execute test cases based on the test script 12. In at least some embodiments of the invention, test script 12 may be a document coded in XML. The test script 12 may pass to the RDF Unit 10 a list of tests cases 14, 16, 18 and 20 that should be run, along with expected results, again possibly in XML form. From the test script 12, the RDF Unit 10 may assemble the selected tests (possibly to form a test suite), may assemble various tests to analyze whether return data from the tests matches expected results, and may also provide startup and teardown operations. For example, and without limitation, a test script 12 may take the following form:

<TC>

<execute>

<test case 1>
<test case N>

</execute>
<results>

<expected result 1>
<expected result N>

</results>

</TC>

If the RDF Unit 10 is Java language based, the RDF Unit 10 may read the test script 12 and produce a Java language coding that calls the various test cases in proper form, and formulate (again possibly in Java) a set of tests to determine whether results of the operations performed by the test cases match expected results passed in the test script 12. Through the RDF API plug-in 28 and the API 26, the RDF Unit 10 may thus perform testing on the RDF based METADATA 22.

FIG. 3 may illustrate a more specific implementation of embodiments of the invention. In particular, RDF Unit 10, again possibly as a wrapper around a JUnit 30, may perform testing on RDF based METADA 22 through a Jena API 32. Jena may be an API created by Hewlett-Packard Company for accessing information coded based on the RDF model. More particularly, Jena may be a Java language based API that is capable of reading, writing, and other such tasks, XML coded information based on the RDF model. Jena is a publicly available API, which may be obtained from Hewlett-Packard's website: http://www.hpl.hp.com/semweb/download.htm. Although RDF Unit 10 may be programmed to communicate with the Jena API 32 directly, in at least some embodiments the RDF Unit 10 may utilize a Jena API plug-in 34, which thus may be a more specific example of an RDF API plug-in 28.

The above discussion is meant to be illustrative of the principles and various embodiments of the present invention. Numerous variations and modifications will become apparent to those skilled in the art once the above disclosure is fully appreciated. For example, while embodiments of the invention may be directed to a unit testing framework for information stored based on a RDF model, the API for that information may likewise or simultaneously be tested using the framework. It is intended that the following claims be interpreted to embrace all such variations and modifications.

What is claimed is:

1. A method comprising:
creating a unit test framework to test a Resource Description Framework (RDF) based object; and
creating a plug-in to access an application program interface (API) of the RDF based object by the unit test framework.

2. The method as defined in claim 1 wherein creating a unit test framework to test a RDF based object further comprises creating a unit test framework based on Java Unit (JUnit) unit test framework.

3. The method as defined in claim 1 wherein creating a unit test framework to test a RDF based object further comprising creating the unit test framework to accept a test script as an input source for formulating tests based on test cases.

4. The method as defined in claim 3 wherein creating the unit test framework to accept a test script further comprises creating the unit test framework to accept a test script in eXtensible Markup Language (XML).

5. The method as defined in claim 1 wherein creating the plug-in to access the API further comprises creating a Java language plug-in to access the API of the RDF based object.

6. The method as defined in claim 1 wherein creating the plug-in to access the API further comprises creating a plug-in to access a Jena API.

7. A computer readable media comprising an executable program that, when executed, implements a method comprising:
accepting a test script by a unit test framework system for Resource Description Framework (RDF) based information;
communicating from the unit test framework system to the RDF based information through an application program interface (API); and
producing results of tests formulated in response to the test script and applied to the RDF based information.

8. The computer readable media as defined in claim 7 wherein the accepting step further comprises accepting the test script for the unit test framework system in eXtensible Markup Language (XML).

9. The computer readable media as defined in claim 8 wherein the test script comprises identification of at least one test case to apply to the RDF based information, and at least one expected result.

10. The computer readable media as defined in claim 7 wherein the communicating from the unit test framework system to the RDF based information step further comprises communicating through an RDF API plug-in from the unit test framework system to the API.

11. The computer readable media as defined in claim 10 wherein the communicating through an RDF API plug-in from the unit test framework system to the API step further comprises communicating through a Jena API plug-in to a Jena API for the RDF based information.

12. The computer readable media as defined in claim 7 wherein the producing results of tests formulated in response to the test script and applied to the RDF based information step further comprises producing the results through a graphical user interface.

13. The computer readable media as defined in claim 7 wherein the producing results of tests formulated in response to the test script and applied to the RDF based information step further comprises producing the results through a command-line interface.

14. The computer readable media as defined in claim 7 wherein the accepting a test script step further comprises accepting a test script by a unit test framework as a logical wrapper around a Java Unit (JUnit) based unit test framework.

15. A method comprising:
supplying a test script to a unit test framework system for Resource Description Framework (RDF) based information;
communicating from the unit test framework system to the RDF based information through an application program interface (API); and
producing results of tests formulated in response to the test script and applied to the RDF based information.

16. The method as defined in claim 15 wherein supplying a test script further comprises supplying a test script to the unit test framework system in eXtensible Markup Language (XML).

17. The method as defined in claim 16 further comprising:
specifying in the test script at least one test case to apply to the RDF based information; and
specifying in the test script at least one expected result.

18. The method as defined in claim 15 wherein communicating from the unit test framework system to the RDF based information further comprises communicating through an RDF API plug-in from the unit test framework system to the API.

19. The method as defined in claim 18 wherein the communicating through an RDF API plug-in from the unit test framework system to the API further comprises communicating through a Jena API plug-in to a Jena API.

20. The method as defined in claim 15 wherein producing results of tests formulated in response to the test script and applied to the RDF based information further comprises producing the results through a graphical user interface.

21. The method as defined in claim 15 wherein producing results of tests formulated in response to the test script and applied to the RDF based information further comprises producing the results through a command-line interface.

22. The method as defined in claim 15 wherein supplying a test script to a unit test framework system for RDF based information further comprises supplying a test script to a unit test framework as a logical wrapper around a Java Unit (JUnit) based unit test framework.
